(19) United States
(12) Patent Application Publication
(10) Pub. No.: US 2023/0245178 A1
(43) Pub. Date: Aug. 3, 2023

(54) AUTOMATICALLY DETERMINING INITIAL AD BIDDING PRICES

(71) Applicant: Walmart Apollo, LLC, Bentonville, AR (US)

(72) Inventors: Biyi Fang, Palo Alto, CA (US); Dong Xu, Sunnyvale, CA (US); Stephen Dean Guo, Saratoga, CA (US)

(73) Assignee: Walmart Apollo, LLC, Bentonville, AR (US)

(21) Appl. No.: 17/589,687

(22) Filed: Jan. 31, 2022

(51) Int. Cl. G06Q 30/02

(52) U.S. Cl. CPC G06Q 30/0275; G06Q 30/0247; G06Q 30/0249

(57) ABSTRACT

A method implemented via execution of computing instructions configured to run at one or more processors and stored at one or more non-transitory computer-readable media. The method can include monitoring periodically whether a respective recommended bidding price update for a campaign type for a user is required for a respective department of campaign departments based on a respective landscape distribution of respective bidding prices for the campaign type for the respective department. The method further can include, after determining that the respective recommended bidding price update is required for the campaign type for the respective department, determining a respective recommended bidding price for a respective target of the respective department based at least in part on the campaign type for the respective target by: (a) determining a respective bidding function for the respective target of the respective department based on the campaign type; and (b) determining the respective recommended bidding price by solving, by using the one or more processors, the respective bidding function for the respective target of the respective department based at least in part on a respective campaign demand, a respective expected performance, a respective winning rate, and a respective cost for the respective target for the user. The method additionally can include, after determining that the respective recommended bidding price update is not required for the campaign type for the respective department, determining that the respective recommended bidding price for the respective target of the respective department for the user is a respective prior bidding price for the respective target without solving the respective bidding function. Other embodiments are described.

### TECHNICAL FIELD

This disclosure relates generally to automatically determining initial advertisement (ad) bidding prices.

### BACKGROUND

Existing ad pricing techniques for e-commerce start an ad bidding procedure by providing an initial ad bid price determined based on prior bids and/or bid sellers’ expectations and then eventually reach a final ad bid price through back and forth negotiations. The procedure is time consuming, while the final bid price is not necessarily satisfying to both parties. Therefore, systems and/or methods for determining initial ad bidding prices that balance the needs of ad sellers are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically initial ad bidding prices, according to an embodiment;

FIG. 4 illustrates a flow chart for a method for automatically determining initial ad bidding prices, according to an embodiment; and

FIG. 5 illustrates activities for a method for determining whether bidding price update is needed, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

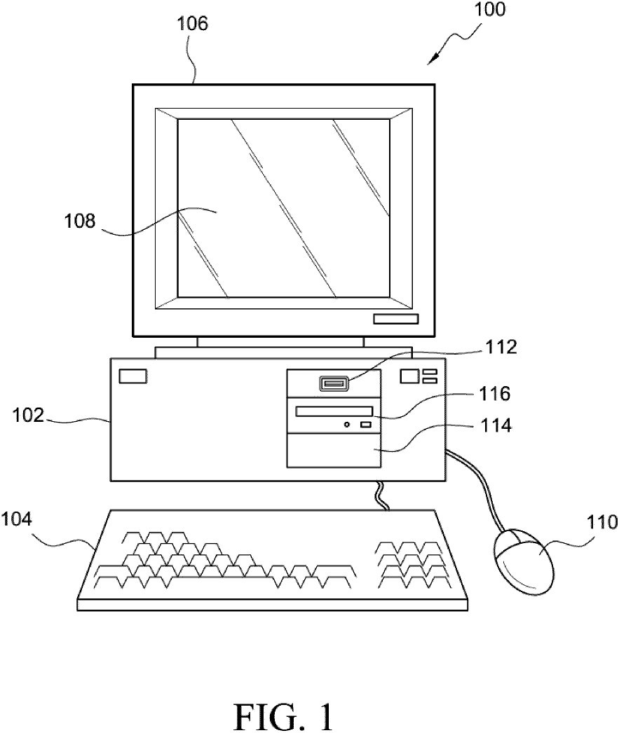

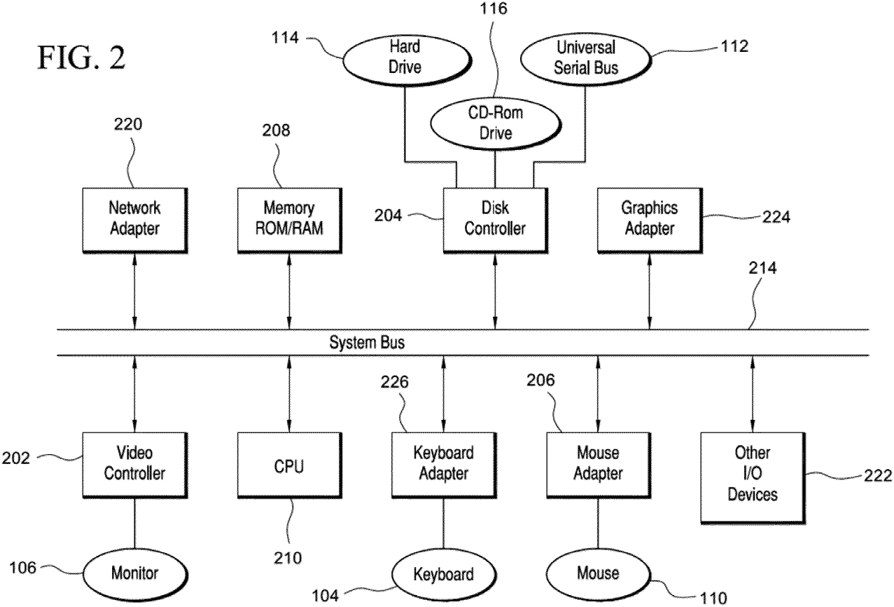

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Washington, United States of America, (ii) Mac® OS Xby Apple Inc. (Apple) of Cupertino, California, United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, California, United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

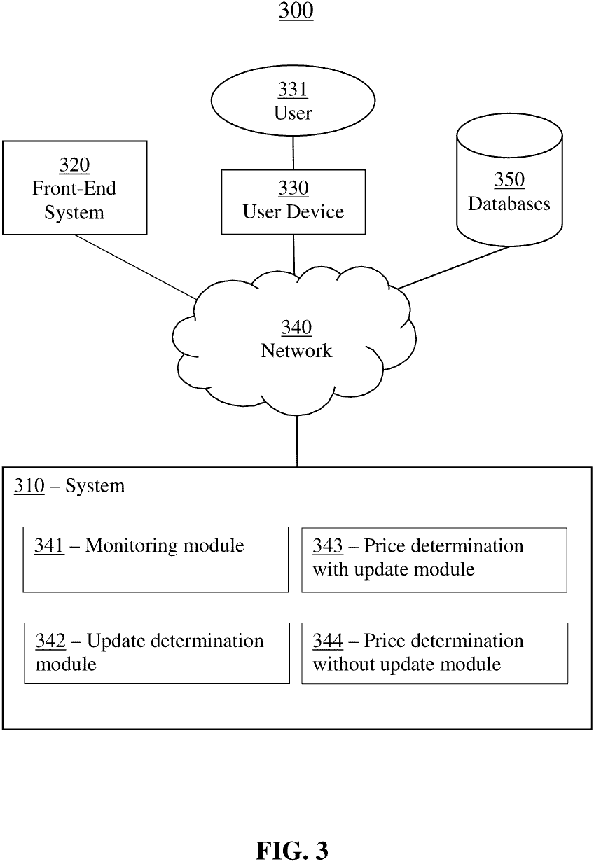

Turning ahead in the drawings, FIG. 3 illustrates a block diagram of a system 300 that can be employed for automatically determining initial ad bidding prices, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310 and/or front-end system 320) and one or more user devices (e.g., user device 330) for various users (e.g., user 331). In a few embodiments, system 310 can include front-end system 320. In the same or different embodiments, system 310 can include monitoring module 341, update determination module 342, price determination with update module 343, and price determination without update module. System 310 (and each of its modules), front-end system 320, and/or user device 330 can each be a computer system, such as computer system 100 (FIG. 1), as described above, and can each be a single computer, a single server, or a cluster or collection of computers or servers, or a cloud of computers or servers. In another embodiment, a single computer system can host each of system 310 (and/or each of its modules), front-end system 320, and/or user device 330. In many embodiments, system 310 and/or each of its modules can be modules of computing instructions (e.g., software modules) stored at non-transitory computer readable media that operate on one or more processors. In other embodiments, system 310 and/or each of its modules can be implemented in hardware or combination of hardware and software. In many embodiments, system 310 and/or each of its modules can comprise one or more systems, subsystems, servers, modules, or models. Additional details regarding system 310, front-end system 320, and/or user device 330 are described herein.

In some embodiments, system 310 and/or each of its modules can be in data communication, through a network 340 (e.g., a computer network, a telephone network, and/or the Internet), with front-end system 320 and/or user device 330. In some embodiments, user device 330 can be used by users (e.g., user 331). In a number of embodiments, front-end system 320 can host one or more websites and/or mobile application servers. For example, front-end system 320 can host a website, or provide a server that interfaces with an application (e.g., a mobile application, a web browser, or a calendar application), on consumer devices, which allow consumers to browse, search, and/or purchase items (e.g., products or produces offered for sale by a retailer) while displaying ads to promote items related to the consumers’ intent, in addition to other suitable activities. In a number of embodiments, users (e.g., user 331) can use user devices (e.g., user device 330) to bid on system 310 for the ads to be displayed on front-end system 320.

In some embodiments, an internal network (e.g., network 340) that is not open to the public can be used for communications between system 310 with front-end system 320, and/or user device 330. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user device 330) can be desktop computers, laptop computers, mobile devices, and/or other endpoint devices used by one or more users (e.g., user 331). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., databases 350). The one or more databases can include an item database, an ads history database, and/or a target ads database. The item database can include information about items which users (e.g., user 331) would promote via ads on front-end system 320. The ads history database can include information about prior ads that have been presented to consumers on front-end system 320, such as respective items associated with the ads, respective click counts, respective click-through-rates (CTRs), respective bid prices, respective cost-per-clicks (CPCs), respective revenue-per-clicks, and so forth. The target ads database can include information about ad campaigns available for bidding, such as respective campaign types, respective prior floor prices, respective floor prices, respective terms, etc.

In some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or databases 350 can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved HighSpeed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can automatically determine recommended bidding prices for campaigns available to users (e.g., user 331). System 310 can be configured to determine the recommended bidding prices down to the item level and provide an optimal ad bidding price for a buyer (e.g., user 331) to bid a target campaign that the buyer likely will succeed to win and that likely will meet a performance goal the buyer defines (e.g., a maximized revenue or click counts, etc.). In some embodiments, system 310 can use any suitable functions, algorithms, or models to determine the recommended bidding prices. In certain embodiments, system 310 can determine the recommended bidding prices on the fly (i.e., in real time) when the users need such information. In similar or different embodiments, system 310 can periodically (e.g., every minute, hour, day, week, month, etc.) update the recommended bidding price for the campaigns to keep the recommended bidding prices.

In view of the voluminous calculations required to determine respective bidding prices for a large quantity of items and campaigns for each user, the task of updating the initial bidding prices can be performed in various ways to increase efficiency and/or save computational resources. For example, system 310 can use parallel computing or distributed computing to determine the respective bidding price for items in different departments. In some embodiments, system 310 can determine whether updating the initial ad bidding prices is necessary before starting the update, in order to save system resources. As a result, the frequencies for updating the initial ad bidding prices can vary for different items or items in different groups (e.g., departments or categories). In several embodiments, system 310 can save the initial ad bidding prices, as determined, input values, and/or parameters used to determine the initial ad bidding prices in a database (e.g., databases 350) for future use.

In a number of embodiments, system 310 can monitor periodically whether a respective recommended bidding price update for a campaign type (e.g., auto / general, or keyword bidding, etc.) for a user (e.g., user 331) is required for a respective department of campaign departments (e.g., appliances, grocery, personal care, gardening, etc.) based on a respective landscape distribution of respective bidding prices for the campaign type for the respective department. System 310 can monitor whether an update is required by: (a) determining a respective prior landscape distribution for the respective bidding prices for the respective department; (b) determining the respective landscape distribution for the respective bidding prices for the respective department; and (c) determining a degree of similarity between the respective prior landscape distribution and the respective landscape distribution for the respective bidding prices.

In some embodiments, the respective prior landscape distribution for the respective bidding prices and/or the respective landscape distribution can be determined based on respective market values of the campaigns, or the respective market values of comparable campaigns. System 310 can use any suitable functions, such as a Kolmogorov-Smirnov test, to determine the degree of similarity between the respective prior landscape distribution and the respective landscape distribution for the respective bidding prices. In certain embodiments, the degree of similarity between the respective prior landscape distribution and the respective landscape distribution for the respective bidding prices can be associated with a significance level of the Kolmogorov-Smirnov test for the respective prior landscape distribution and the respective landscape distribution for the respective bidding prices. In a number of embodiments, when the degree of similarity is less than a predetermined threshold (e.g., 88%, 90%, 93%, 95%, etc.), determining that the respective recommended bidding price update is required.

In a number of embodiments, after determining that the respective recommended bidding price update is not required for the campaign type for the respective department, system 310 can determine that the respective recommended bidding price for a respective target (e.g., a specific ad slot on a user interface for browsing products or displaying search results, etc.) of a respective department for the user is a respective prior bidding price for the respective target, without solving any functions or performing any calculations, thus not further wasting time or resources. The respective prior bidding price for the respective target can be stored in a data base (e.g., databases 350, the target ads database described above, etc.).

In many embodiments, after determining that the respective recommended bidding price update is required for the campaign type for the respective department, system 310 can determine a respective recommended bidding price for a respective target of the respective department based at least in part on the campaign type for the respective target by: (a) determining a respective bidding function for the respective target of the respective department based on the campaign type (e.g., auto/general bidding or keyword bidding); and (b) determining the respective recommended bidding price by solving, by using the one or more processors, the respective bidding function for the respective target of the respective department based at least in part on a respective campaign demand (e.g., how popular the respective campaign is), a respective expected performance (e.g., an expected click-through-rate or revenue-per-click, etc.), a respective winning rate (e.g., how likely bidding on the respective target with the respective recommended bidding price will win), and/or a respective cost for the respective target for the user.

In a number of embodiments, solving the respective bidding function for the respective target of the respective department further can include solving, by using the one or more processors, the respective bidding function for the respective target of the respective department further based on various inputs. Examples of the inputs for the respective bidding function can include a respective related campaign demand for: (a) a respective campaign item of a campaign for the respective target, or (b) a respective keyword of a keyword group for the respective target. The respective related campaign demand can be determined based on bidding activities of other users and/or the same user. For instance, the respective related campaign demand can be associated with the numbers of bid requests for the respective campaign item of the campaign for the respective target or for the respective keyword of the keyword group for the respective target.

Examples of the inputs for the respective bidding function further can include a respective utility function for the respective campaign item or the respective keyword. An exemplary utility function can include a click count or a revenue that the campaign is expected to generate. In some embodiments, the inputs for the respective bidding function for the respective target of the respective department also can include a respective click-through-rate (CTR) for the respective campaign item or the respective keyword. The CTR can be calculated in real-time based on historical data stored in a database (e.g., databases 350 or the ads history database as described above, etc.) or be retrieved from the database or a different database updated in the previous calculation cycle within a certain time period (e.g., 24 hours, 3 days, etc.).

In several embodiments, the inputs for the respective bidding function additionally can include a respective related campaign winning rate for: (a) an item bidding price for the respective campaign item, or (b) a keyword bidding price for the respective keyword. The respective related campaign winning rate can be determined based on bidding activities of other users or the same user. For instance, the respective related campaign winning rate can include a respective historical winning rate for a prior bidding price for either a campaign item or the respective keyword.

In a few embodiments, the inputs for the respective bidding function further can include a respective cost function (e.g., a base price, a cost incurred based on a click count, etc. when the ad is posted) for the respective campaign item or the respective keyword; a respective revenue for the respective campaign item or the respective keyword; a budget for the campaign or the keyword group; and/or a respective floor price (e.g., the minimum bidding price acceptable to the ad seller or the e-commerce platform) for the respective campaign item or the respective keyword.

In some embodiments, the respective campaign demand for the respective target (e.g., the demand for the respective campaign that includes the respective target) can include the respective campaign demand for the respective target. The respective expected performance for the respective target can include the respective click-through-rate for the respective target or the respective revenue for the respective target. The respective winning rate for the respective target can include the respective related campaign winning rate for the respective target. The respective cost for the respective target is associated with the respective floor price for the respective target.

In many embodiments, system 300 further can include transmitting, via network 350, a user interface to be executed on a user device (e.g., user device 330) for the user (e.g., user 331) to provide one or more campaign inputs to the one or more processors. The one or more campaign inputs can include: the campaign type (e.g., auto or keyword campaign); a respective campaign objective; the respective cost function for the respective campaign item or the respective keyword; and/or a winning rate prediction function for determining the respective winning rate for the item bidding price or the keyword bidding price.

For example, the respective campaign objective, as provided by the user, can include: an optimal total-clicks, an optimal total revenue, or an optimal return-of-ad-return. The respective cost function, as provided by the user, can be associated with an ordered sequence of bidding prices (predetermined or calculated based on a predetermined function) for multiple bids. The winning rate prediction function, as provided by the user, can be associated with one of: a diminishing market price distribution or a uniform market price distribution. The respective utility function for the respective campaign item or the respective keyword can be associated with the respective campaign objective.

In some embodiments, system 310 also can determine the respective floor price for the respective campaign item or the respective keyword. The respective floor price can be determined based on information about prior ads for the respective campaign item and/or the respective keywords, such as a respective cost-per-click, a respective revenue-per-click, a respective click count, a respective prior floor price, and a respective prior click count for the respective campaign item or the respective keyword, etc.

Still referring to FIG. 3, in a number of embodiments, system 310 can solve, by using the one or more processors, the respective bidding function for the respective target further based at least in part on a Lagrangian function and one or more Euler-Lagrange conditions.

In some embodiments, system 310 can include the following bidding function for the respective target of the respective department. In certain embodiments, the following bidding function can be used for auto/general bidding (e.g., bidding on ad slots on general webpages, including webpages for search results based on all of the keywords).

$$\begin{matrix}{max}_{{b}_{i} ( )} {\sum }_{l} {T}_{i} {\int }_{r} u \left(r\right) w \left({b}_{i} \left(r\right)\right) {p}_{r} \left(r\right) d r \\ \text{s} \text{.t} \text{.} {\sum }_{l} {T}_{i} {\int }_{r} c \left({b}_{i} \left(r\right)\right) w \left({b}_{i} \left(r\right)\right) {p}_{r} \left(r\right) d r \leq B , {b}_{e} \leq {b}_{i} \leq {v}_{i} .\end{matrix}$$

Here, Tᵢ is a campaign demand for item i of a campaign, the campaign comprising the respective target. r is a click-through-rate (CTR) for item i. u(r) is a utility function for CTR r for the campaign. bᵢ(r) is a bidding price for CTR r for item i. w(bᵢ(r)) is a winning rate for bidding price bᵢ(r). pᵣ(r) is a distribution of CTR r. c(bᵢ(r)) is a cost function for bidding price bᵢ(r). B is a budget for the campaign. b_{ε} is a floor price for the campaign. vᵢ is a revenue for item i.

Further, in several embodiments, the Lagrangian function can include:

$$\begin{matrix}L \left({b}_{i} \left(r\right) , λ\right) = {\sum }_{i} {T}_{i} {\int }_{r} u \left(r\right) w \left({b}_{i} \left(r\right)\right) {p}_{r} \left(r\right) d r + {λ}_{1} \left(B -\right) \\ {\sum }_{i} {T}_{i} {\int }_{r} c \left({b}_{i} \left(r\right)\right) w \left({b}_{i} \left(r\right) {p}_{r} \left(r\right) d r - {s}_{1}^{2}\right) + {λ}_{2} \left({v}_{i} - {b}_{i} - {s}_{2}^{2}\right) + \\ {λ}_{3} \left({b}_{i} - {b}_{\text{ε}} - {s}_{3}^{2}\right) .\end{matrix}$$

Here, each of λ₁, λ₂, and λ₃ each is a Lagrange multiplier; and each of s₁, s₂, and s₃ is a variable.

The one or more Euler-Lagrange conditions, when first price auction is applied and assuming diminishing ranking score distribution, can include:

$$B - {T}_{i} {\int }_{r} c \left({b}_{i} \left(r\right)\right) w \left({b}_{i} \left(r\right)\right) {p}_{r} \left(r\right) d r - {s}_{1}^{2} = 0 ; \text{and}$$

$${b}_{i} \left(r\right) = \sqrt{\frac{{l}^{2}}{{r}_{p}^{2} \left({P}_{i}\right)} + \frac{l u \left(r\right)}{{λ}_{1} {r}_{p} \left({P}_{i}\right)}} - \frac{l}{{r}_{p} \left({P}_{i}\right)} .$$

Here, l is a constant; and rₚ(Pᵢ) is a predicted click-through-rate (CTR) for product Pi.

In many embodiments, system 310 further can include the following bidding function (e.g., bᵢ(r)) for the respective target of the respective department. In some embodiments, the following bidding function can be used for keyword bidding (e.g., bidding on ad slots on webpages for search results based on specific keywords).

$$\begin{matrix}{max}_{{b}_{{k}_{i}}} {\sum }_{{k}_{i} ∈ K} {T}_{{k}_{i}} u \left({b}_{{k}_{i}}\right) w \left({b}_{{k}_{i}}\right) {r}_{{k}_{i}} \\ \text{s} \text{.t} \text{.} {\sum }_{{k}_{i} ∈ K} {T}_{{k}_{i}} c \left({b}_{{k}_{i}}\right) w \left({b}_{{k}_{i}}\right) {r}_{{k}_{i}} \leq B , {b}_{ε} \leq {b}_{{k}_{i}} \leq {v}_{{k}_{i}} ∀ i ,\end{matrix}$$

Here, Tₖᵢ is a campaign demand for keyword kᵢ of a keyword group, the keyword group comprising the respective target. rₖᵢ, is a click-through-rate (CTR) for keyword kᵢ bₖ is a bidding price for keyword kᵢ u(bₖ) is a utility function for bidding price bₖ. w(bₖ) is a winning rate for bidding price bₖ. c(bₖ) is a cost function for bidding price bₖ. B is a budget for the keyword group. b_{ε} is a floor price for the keyword group. vₖᵢ is a revenue for keyword kᵢ

The Lagrangian function can include:

$$\begin{matrix}L \left({b}_{{k}_{i}} , λ\right) = {\sum }_{{k}_{i} ∈ K} {T}_{{k}_{i}} u \left({b}_{{k}_{i}}\right) w \left({b}_{{k}_{i}}\right) {r}_{{k}_{i}} + {λ}_{1} \left(B - {\sum }_{i} {T}_{{k}_{i}} c \left({b}_{{k}_{i}}\right) w \left({b}_{{k}_{i}}\right)\right) \\ \left({r}_{{k}_{i}}\right) + {λ}_{2} \left({v}_{{k}_{i}} - {b}_{{k}_{i}} - {s}_{2}^{2}\right) + {λ}_{3} \left({b}_{{k}_{i}} - {b}_{\text{ε}} - {s}_{3}^{2}\right) .\end{matrix}$$

Here, each of λ₁, λ₂, and λ₃, is a Lagrange multiplier; and each of s₁, s₂, and s₃ is a variable.

The one or more Euler-Lagrange conditions, when first price auction is applied and assuming diminishing ranking score distribution, can include:

$$B - {T}_{{k}_{i}} c \left({b}_{{k}_{i}}\right) w \left({b}_{{k}_{i}}\right) {r}_{{k}_{i}} = 0 ; \text{and}$$

$${b}_{{k}_{i}} = \sqrt{\frac{{l}^{2}}{{r}_{p}^{2} \left({k}_{i}\right)} + \frac{l u \left({b}_{{k}_{i}}\right)}{{λ}_{1} {r}_{p} \left({k}_{i}\right)}} - \frac{l}{{r}_{p} \left({k}_{i}\right)} .$$

Here, l is a constant; and rₚ(kᵢ) is a predicted click-through-rate (CTR) for keyword kᵢ.

In many embodiments, system 310 further can, after determining the respective recommended bidding price, allow the user (e.g., user 331 or a buyer) to adjust the respective recommended bidding price before submitting the bid. In a few embodiments, system 310 further can allow the user and other users to auction, via user devices (e.g., user devices 330) through network 350, the respective target by providing user interfaces to be executed on the user devices.

Conventional systems are unable to automatically determine ad bidding prices that not only satisfy the seller’s pricing requirements but also take into the buyer’s expectations of winning rates, cost, and benefits of the ads. This is because conventional systems typically use fixed functions to determine ad bidding prices based on historical prices, and let buyers gauge the costs and performance of the ads and negotiate reasonable prices for the buyers. As such, system 300 and/or system 310 are advantageous because they determine initial ad bidding prices based on the floor prices and historical performance data while being flexible in that they allow users/buyers to choose the campaign type and/or objective function.

Further, in many embodiments, system 300 and/or system 310 are advantageous because the ad prices for each ad or ads in each department can be updated at different frequencies. Because the performance data and costs for ads change over time, the ad bidding prices need to be updated frequently. Nonetheless, updating the ad bidding prices requires enormous amount of time and computing resources. In certain embodiments, bidding prices may change less frequently for some departments than others, or the changes may have different seasonal effects. As such, by determining whether a respective recommended bidding price update for a campaign type for a user is required before the price determining process, system 300 and/or system 310 save time and computational resources.

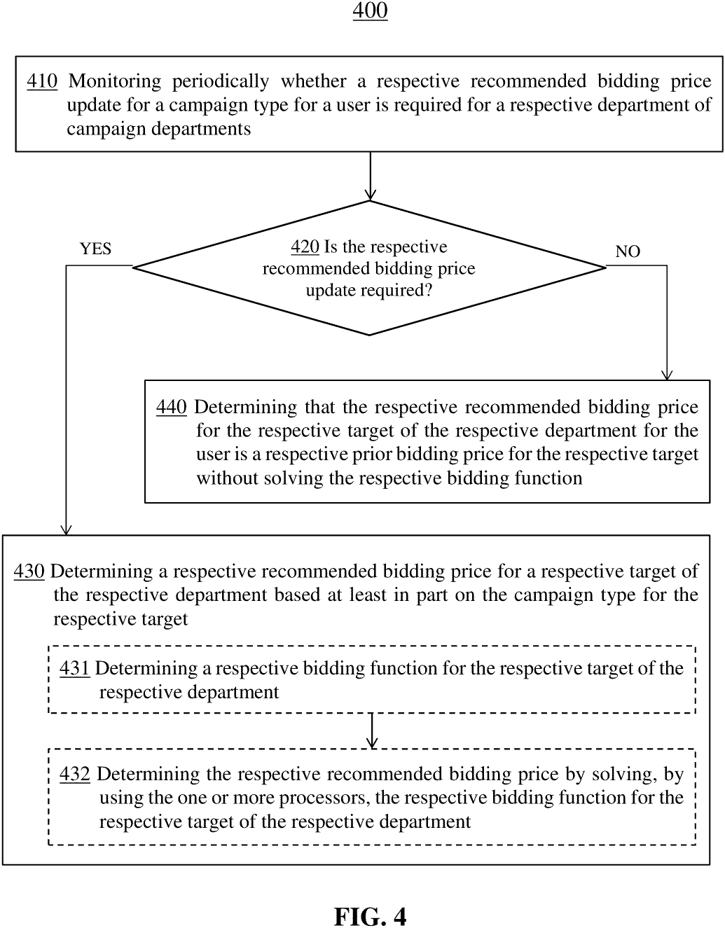

Turning ahead in the drawings, FIG. 4 illustrates a flow chart for a method 400, according to an embodiment. In many embodiments, method 400 can be implemented via execution of computing instructions on one or more processors for automatically determining an offer price for an order delivery. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

In many embodiments, method 400 can be performed by a computer server, such as system 300 (FIG. 3) and/or system 310 (FIG. 3), to monitor periodically whether a respective recommended bidding price update for a campaign type for a user (e.g., user 331 (FIG. 3)) is required for a respective department of campaign departments (block 410). In some embodiments, method 400 can include monitoring periodically whether the respective recommended bidding price update for the campaign type for the user is required based on a respective landscape distribution of respective bidding prices for the campaign type for the respective department. As an example, monitoring module 341 (FIG. 3) in system 310 (FIG. 3) can perform the functions of block 410.

In a number of embodiments, method 400 further can include determining what to do after the monitoring in block 410 (block 420). When it is determined in block 420 that the respective recommended bidding price update is required, method 400 further can perform the activities in block 430. When it is determined in block 420 that the respective recommended bidding price update is not required, method 400 then can perform the activities in block 440. As an example, update determination module 342 (FIG. 3) in system 310 (FIG. 3) can perform the functions of block 420.

In some embodiments, method 400 can include, as determined in block 420 that the respective recommended bidding price update is required, determining a respective recommended bidding price for a respective target of the respective department based at least in part on the campaign type for the respective target (block 430). As an example, price determination with update module 343 (FIG. 3) in system 310 (FIG. 3) can perform the functions of block 430.

In several embodiments, determining the respective recommended bidding price for the respective target of the respective department in block 430 can include determining a respective bidding function for the respective target of the respective department (block 431). In some embodiments, the respective bidding function can be determined based on the campaign type. In a few embodiments, the bidding function for auto bidding can be similar or different from that of keyword bidding. In certain embodiments, the respective bidding function for each department can be similar or different.

In the same or different embodiments, determining the respective recommended bidding price for the respective target of the respective department in block 430 can further include determining the respective recommended bidding price by solving, by using the one or more processors, the respective bidding function for the respective target of the respective department (block 432). In a number of embodiments, solving, by using the one or more processors, the respective bidding function for the respective target of the respective department in block 432 can be based at least in part on a respective campaign demand, a respective expected performance, a respective winning rate, and/or a respective cost for the respective target for the user. The respective expected performance can include a respective utility function for the respective campaign item or the respective keyword and/or a respective click-through-rate for the respective campaign item or the respective keyword, etc.

In a number of embodiments, method 400 additionally can include, as determined in block 420 that the respective recommended bidding price update is not required, determining that the respective recommended bidding price for the respective target of the respective department for the user is a respective prior bidding price for the respective target without solving the respective bidding function (block 440). As an example, price determination without update module 344 (FIG. 3) in system 310 (FIG. 3) can perform the functions of block 440.

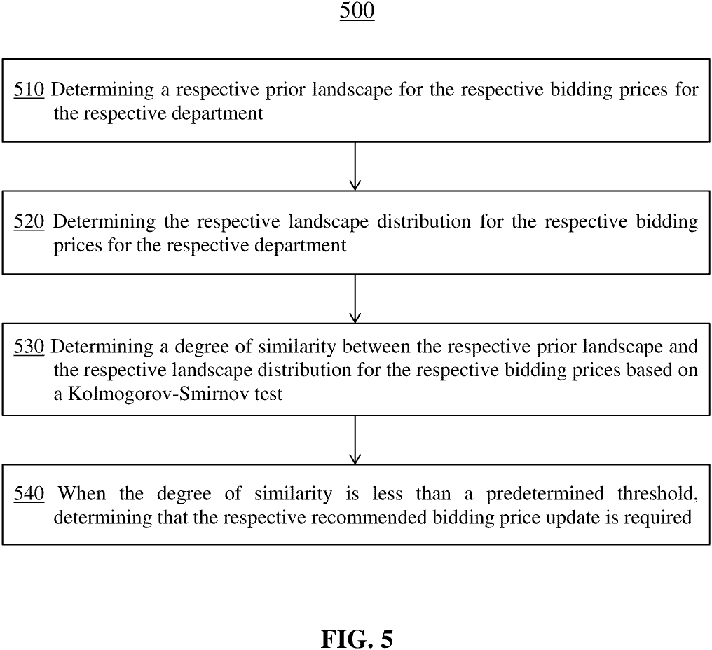

Turning ahead in the drawings, FIG. 5 illustrates activities for a method 500, according to an embodiment. In many embodiments, method 500 can be the same as block 410 (FIG. 4) in method 400 (FIG. 4).

In many embodiments, method 500 can be implemented via execution of computing instructions on one or more processors, and the computing instructions can be stored at one or more non-transitory computer-readable media and, when executed on the one or more processors, perform automatically determining a delivery offer price for a delivery request. Method 500 is merely exemplary and is not limited to the embodiments presented herein. Method 500 can be employed in many different embodiments or examples not specifically depicted or described herein. In certain embodiments, method 500 can be employed to perform one or more activities in block 410 (FIG. 4). In some embodiments, the procedures, the processes, the activities, and/or the blocks of method 500 can be performed in the order presented. In other embodiments, the procedures, the processes, the activities, and/or the blocks of method 500 can be performed in any suitable order. In still other embodiments, one or more of the procedures, the processes, the activities, and/or the blocks of method 500 can be combined or skipped.

In many embodiments, system 300 (FIG. 3) and/or system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 5, method 500 can be performed by a computer server, such as system 300 (FIG. 3) and/or system 310 (FIG. 3), to determine a respective prior landscape distribution for the respective bidding prices for the respective department (block 510). The respective prior landscape distribution can be determined in real-time or retrieved from a database (e.g., databases 350 (FIG. 3)).

In some embodiments, method 500 further can include determining the respective landscape distribution for the respective bidding prices for the respective department (block 520). In a few embodiments, the time difference between the respective prior landscape distribution and the respective landscape distribution can be any suitable values, such as 3 days, a week, 2 weeks, a month, etc.

In several embodiments, method 500 further can include determining a degree of similarity between the respective prior landscape distribution and the respective landscape distribution for the respective bidding prices based on a Kolmogorov-Smirnov test (block 530). In similar or different embodiments, method 500 can include determining the degree of similarity based on other suitable functions.

In many embodiments, method 500 further can include, when the degree of similarity is less than a predetermined threshold, determining that the respective recommended bidding price update is required. In some embodiments, the degree of similarity between the respective prior landscape and the respective landscape distribution for the respective bidding prices can be associated with a significance level of the Kolmogorov-Smirnov test for the respective prior landscape and the respective landscape distribution for the respective bidding prices, and the predetermined threshold can associated with a significance level of 95%.

Various embodiments can include a system for determining ad bidding prices. The system can include one or more processors and one or more non-transitory computer-readable media storing computing instructions that, when executed on the one or more processors, cause the one or more processors to perform various acts. In a number of embodiments, the acts can include monitoring periodically whether a respective recommended bidding price update for a campaign type for a user is required for a respective department of campaign departments based on a respective landscape distribution of respective bidding prices for the campaign type for the respective department.

In some embodiments, the acts further can include, after determining that the respective recommended bidding price update is required for the campaign type for the respective department, determining a respective recommended bidding price for a respective target of the respective department based at least in part on the campaign type for the respective target by: (a) determining a respective bidding function for the respective target of the respective department based on the campaign type; and (b) determining the respective recommended bidding price by solving, by using the one or more processors, the respective bidding function for the respective target of the respective department based at least in part on a respective campaign demand, a respective expected performance, a respective winning rate, and a respective cost for the respective target for the user.

In many embodiments, the acts further can include, after determining that the respective recommended bidding price update is not required for the campaign type for the respective department, determining that the respective recommended bidding price for the respective target of the respective department for the user is a respective prior bidding price for the respective target without solving the respective bidding function.

Further, various embodiments can include a method being implemented via execution of computing instructions configured to run at one or more processors and stored at one or more non-transitory computer-readable media. The method can comprise monitoring periodically whether a respective recommended bidding price update for a campaign type for a user is required for a respective department of campaign departments based on a respective landscape distribution of respective bidding prices for the campaign type for the respective department. The method further can include, after determining that the respective recommended bidding price update is required for the campaign type for the respective department, determining a respective recommended bidding price for a respective target of the respective department based at least in part on the campaign type for the respective target by: (a) determining a respective bidding function for the respective target of the respective department based on the campaign type; and (b) determining the respective recommended bidding price by solving, by using the one or more processors, the respective bidding function for the respective target of the respective department based at least in part on a respective campaign demand, a respective expected performance, a respective winning rate, and a respective cost for the respective target for the user. The method additionally can include, after determining that the respective recommended bidding price update is not required for the campaign type for the respective department, determining that the respective recommended bidding price for the respective target of the respective department for the user is a respective prior bidding price for the respective target without solving the respective bidding function.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically determining ad bidding prices has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. Different functions can be used to determine whether a respective recommended bidding price update for a campaign type for a user is required. Other suitable bidding functions also may be used to determine the ad bidding prices.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform functions comprising:
monitoring periodically whether a respective recommended bidding price update for a campaign type for a user is required for a respective department of campaign departments based on a respective landscape distribution of respective bidding prices for the campaign type for the respective department;
after determining that the respective recommended bidding price update is required for the campaign type for the respective department, determining a respective recommended bidding price for a respective target of the respective department based at least in part on the campaign type for the respective target by:
determining a respective bidding function for the respective target of the respective department based on the campaign type; and
determining the respective recommended bidding price by solving, by using the one or more processors, the respective bidding function for the respective target of the respective department based at least in part on a respective campaign demand, a respective expected performance, a respective winning rate, and a respective cost for the respective target for the user; and
after determining that the respective recommended bidding price update is not required for the campaign type for the respective department, determining that the respective recommended bidding price for the respective target of the respective department for the user is a respective prior bidding price for the respective target without solving the respective bidding function.

2. The system in claim 1, wherein:
monitoring periodically whether the respective recommended bidding price update is required for the campaign type for the respective department further comprises:
determining a respective prior landscape distribution for the respective bidding prices for the respective department;
determining the respective landscape distribution for the respective bidding prices for the respective department;
determining a degree of similarity between the respective prior landscape distribution and the respective landscape distribution for the respective bidding prices based on a Kolmogorov-Smirnov test; and
when the degree of similarity is less than a predetermined threshold, determining that the respective recommended bidding price update is required.

3. The system in claim 2, wherein:
the degree of similarity between the respective prior landscape distribution and the respective landscape distribution for the respective bidding prices is associated with a significance level of the Kolmogorov-Smirnov test for the respective prior landscape distribution and the respective landscape distribution for the respective bidding prices; and
the predetermined threshold is associated with a significance level of 95%.

4. The system in claim 1, wherein:
solving the respective bidding function for the respective target of the respective department further comprises solving, by using the one or more processors, the respective bidding function for the respective target of the respective department further based on one or more of:
a respective related campaign demand for: (a) a respective campaign item of a campaign for the respective target, or (b) a respective keyword of a keyword group for the respective target;
a respective utility function for the respective campaign item or the respective keyword;
a respective click-through-rate for the respective campaign item or the respective keyword;
a respective related campaign winning rate for: (a) an item bidding price for the respective campaign item, or (b) a keyword bidding price for the respective keyword;
a respective cost function for the respective campaign item or the respective keyword;
a respective revenue for the respective campaign item or the respective keyword;
a budget for the campaign or the keyword group; or
a respective floor price for the respective campaign item or the respective keyword; the respective campaign demand for the respective target comprises the respective related campaign demand for the respective target;
the respective expected performance for the respective target comprises the respective click-through-rate for the respective target or the respective revenue for the respective target;
the respective winning rate for the respective target comprises the respective related campaign winning rate for the respective target; and
the respective cost for the respective target is associated with the respective floor price for the respective target.

5. The system in claim 4, wherein:
the computing instructions, when executed on the one or more processors, further cause the one or more processors to perform transmitting, via a computer network, a user interface to be executed on a user device for the user to provide one or more campaign inputs to the system; and
the one or more campaign inputs include one or more of:
the campaign type;
a respective campaign objective;
the respective cost function for the respective campaign item or the respective keyword; or
a winning rate prediction function for determining the respective winning rate for the item bidding price or the keyword bidding price.

6. The system in claim 5, wherein:
one or more of:
the campaign type, as provided by the user, comprises an auto bidding or a keyword bidding;
the respective campaign objective, as provided by the user, comprises one of: an optimal total-clicks, an optimal total revenue, or an optimal retum-of-ad-return;
the respective cost function, as provided by the user, is associated with an ordered sequence of bidding prices for multiple bids; or
the winning rate prediction function, as provided by the user, is associated with one of: a diminishing market price distribution or a uniform market price distribution; and
the respective utility function for the respective campaign item or the respective keyword is associated with the respective campaign objective.

7. The system in claim 4, wherein:
the computing instructions, when executed on the one or more processors, further cause the one or more processors to perform determining the respective floor price for the respective campaign item or the respective keyword based at least in part on a respective cost-per-click, a respective revenue-per-click, a respective click count, a respective prior floor price, and a respective prior click count for the respective campaign item or the respective keyword.

8. The system in claim 1, wherein:
the respective bidding function for the respective target of the respective department comprises one of:
(a)
$$\text{s} \text{.t} \text{.} {\begin{matrix}{max}_{{b}_{i} \left(\right)} {\sum }_{i}^{} {T}_{i} {\int }_{r}^{} u \left(r\right) w \left({b}_{i} \left(r\right)\right) {p}_{r} \left(r\right) d r \\ {\sum }_{\text{t}}^{} {T}_{i} {\int }_{\text{f}} c \left({b}_{t} \left(r\right)\right) w \left({b}_{i} \left(r\right)\right) {p}_{r} \left(r\right) d r \leq B , {b}_{e} \leq {b}_{i} \leq {v}_{i} .\end{matrix}}_{,}$$
wherein:
Tᵢ is a campaign demand for item i of a campaign, the campaign comprising the respective target;
r is a click-through-rate (CTR) for item i;
u(r) is a utility function for CTR r for the campaign;
bᵢ(r) is a bidding price for CTR r for item i;
w(bᵢ(r)) is a winning rate for bidding price bᵢ(r);
pᵣ(r) is a distribution of CTR r;
c(bᵢ(r)) is a cost function for bidding price bᵢ(r);
B is a budget for the campaign;
b_{ε} is a floor price for the campaign; and
vᵢ is a revenue for item i;
or
(b)
$$\text{s} \text{.t} \text{.} {\begin{matrix}{max}_{{b}_{{k}_{i}}} {\sum }_{{k}_{i} ∈ K}^{} {T}_{{k}_{i}} u \left({b}_{{k}_{i}}\right) w \left({b}_{{k}_{i}}\right) {r}_{{k}_{i}} \\ {\sum }_{{k}_{i} ∈ K}^{} {T}_{{k}_{i}} c \left({b}_{{k}_{i}}\right) w \left({b}_{{k}_{i}}\right) {r}_{{k}_{i}} \leq B , {b}_{e} \leq {b}_{k ,} \leq {v}_{{k}_{i}} ∀ i ,\end{matrix}}_{,}$$
wherein:
Tₖᵢ is a campaign demand for keyword kᵢ of a keyword group, the keyword group comprising the respective target;
rₖᵢ is a click-through-rate (CTR) for keyword kᵢ;
bₖ is a bidding price for keyword kᵢ;
u(bₖ) is a utility function for bidding price bₖ;
w(bₖ) is a winning rate for bidding price bₖ;
c(bₖ) is a cost function for bidding price bₖ;
B is a budget for the keyword group;
b_{ε} is a floor price for the keyword group; and
vₖᵢ is a revenue for keyword kᵢ.

9. The system in claim 8, wherein:
solving, by using the one or more processors, the respective bidding function further comprises solving, by using the one or more processors, the respective bidding function based at least in part on a Lagrangian function and one or more Euler-Lagrange conditions; and
the Lagrangian function comprises one of:
(a)
$$\begin{matrix}L \left({b}_{i} \left(r\right) , λ\right) = \sum {}_{i} {T}_{i} {\int }_{r} u \left(r\right) w \left({b}_{i} \left(r\right)\right) {p}_{r} \left(r\right) d r + {λ}_{1} \left(B -\right) \\ \sum {}_{i} {T}_{i} {\int }_{r} c \left({b}_{i} \left(r\right)\right) w \left({b}_{i} \left(r\right) {p}_{r} \left(r\right) d r - {s}_{1}^{2}\right) + {λ}_{2} \left({v}_{i} - {b}_{i} - {s}_{2}^{2}\right) + {λ}_{3} \left({b}_{i} -\right) \\ {b}_{ε} - \left({s}_{3}^{2}\right) ;\end{matrix}$$
or
(b)
$$\begin{matrix}L \left({b}_{i} \left(r\right) , λ\right) = \sum {}_{{k}_{i} ∈ K} {T}_{{k}_{i} ∈ K} {T}_{{k}_{i}} u \left({b}_{{k}_{i}}\right) w \left({b}_{{k}_{i}}\right) {r}_{{k}_{i}} + {λ}_{1} \left(B - \sum {}_{i} {T}_{{k}_{i}} c \left({b}_{{k}_{i}}\right) {r}_{{k}_{i}}\right) + \\ {λ}_{2} \left({v}_{{k}_{i}} - {b}_{{k}_{i}} - {s}_{2}^{2}\right) + {λ}_{3} \left({b}_{{k}_{i}} - {b}_{ε} - {s}_{3}^{2}\right) ,\end{matrix}$$
wherein:
each of λ₁, λ₂, and λ₃ is a Lagrange multiplier; and
each of s₁, s₂, and s₃ is a variable.

10. The system in claim 9, wherein:
the one or more Euler-Lagrange conditions comprises one of:
(a)
$$\begin{matrix}B - {T}_{i} {\int }_{r} c \left({b}_{i} \left(r\right)\right) w \left({b}_{i} \left(r\right)\right) {p}_{r} \left(r\right) d r - {s}_{1}^{2} = 0 ; \text{and} \\ {b}_{i} \left(r\right) = \sqrt{\frac{{l}^{2}}{{r}_{p}^{2} \left({p}_{i}\right)} + \frac{l u \left(r\right)}{{λ}_{1} {r}_{p} \left({p}_{i}\right)} - \frac{l}{{r}_{p} \left({p}_{i}\right)}} ;\end{matrix}$$
or
(b)
$$\begin{matrix}B - {T}_{{k}_{i}} C \left({b}_{{k}_{i}}\right) w \left({b}_{{k}_{i}}\right) {r}_{{k}_{i}} \text{} = 0 ; \text{and} \\ {b}_{{k}_{i}} = \sqrt{\frac{{l}^{2}}{{r}_{p}^{2} \left({k}_{i}\right)} + \frac{l u \left({b}_{{k}_{i}}\right)}{{λ}_{1} {r}_{p} \left({k}_{i}\right)} \text{}} - \frac{l}{{r}_{p} \left({k}_{i}\right)} ,\end{matrix}$$
wherein:
l is a constant;
rₚ(Pᵢ) is a predicted click-through-rate (CTR) for product Pᵢ; and
rₚ(kᵢ) is a predicted click-through-rate (CTR) for keyword kᵢ.

11. A method being implemented via execution of computing instructions configured to run at one or more processors and stored at one or more non-transitory computer-readable media, the method comprising:
monitoring periodically whether a respective recommended bidding price update for a campaign type for a user is required for a respective department of campaign departments based on a respective landscape distribution of respective bidding prices for the campaign type for the respective department;
after determining that the respective recommended bidding price update is required for the campaign type for the respective department, determining a respective recommended bidding price for a respective target of the respective department based at least in part on the campaign type for the respective target by:
determining a respective bidding function for the respective target of the respective department based on the campaign type; and
determining the respective recommended bidding price by solving, by using the one or more processors, the respective bidding function for the respective target of the respective department based at least in part on a respective campaign demand, a respective expected performance, a respective winning rate, and a respective cost for the respective target for the user; and
after determining that the respective recommended bidding price update is not required for the campaign type for the respective department, determining that the respective recommended bidding price for the respective target of the respective department for the user is a respective prior bidding price for the respective target without solving the respective bidding function.

12. The method in claim 11, wherein:
monitoring periodically whether the respective recommended bidding price update is required for the respective department further comprises:
determining a respective prior landscape distribution for the respective bidding prices for the respective department;
determining the respective landscape distribution for the respective bidding prices for the respective department;
determining a degree of similarity between the respective prior landscape distribution and the respective landscape distribution for the respective bidding prices based on a Kolmogorov-Smirnov test; and
when the degree of similarity is less than a predetermined threshold, determining that the respective recommended bidding price update is required.

13. The method in claim 12, wherein:
the degree of similarity between the respective prior landscape distribution and the respective landscape distribution for the respective bidding prices is associated with a significance level of the Kolmogorov-Smirnov test for the respective prior landscape distribution and the respective landscape distribution for the respective bidding prices; and
the predetermined threshold is associated with a significance level of 95%.

14. The method in claim 11, wherein:
solving the respective bidding function for the respective target of the respective department further comprises solving, by using the one or more processors, the respective bidding function for the respective target of the respective department further based on one or more of:
a respective related campaign demand for: (a) a respective campaign item of a campaign for the respective target, or (b) a respective keyword of a keyword group for the respective target;
a respective utility function for the respective campaign item or the respective keyword;
a respective click-through-rate for the respective campaign item or the respective keyword;
a respective related campaign winning rate for: (a) an item bidding price for the respective campaign item, or (b) a keyword bidding price for the respective keyword;
a respective cost function for the respective campaign item or the respective keyword;
a respective revenue for the respective campaign item or the respective keyword;
a budget for the campaign or the keyword group; or
a respective floor price for the respective campaign item or the respective keyword; the respective campaign demand for the respective target comprises the respective related campaign demand for the respective target;
the respective expected performance for the respective target comprises the respective click-through-rate for the respective target or the respective revenue for the respective target;
the respective winning rate for the respective target comprises the respective related campaign winning rate for the respective target; and
the respective cost for the respective target is associated with the respective floor price for the respective target.

15. The method in claim 14 further comprising:
transmitting, via a computer network, a user interface to be executed on a user device for the user to provide one or more campaign inputs to the one or more processors,
wherein:
the one or more campaign inputs include one or more of:
the campaign type;
a respective campaign objective;
the respective cost function for the respective campaign item or the respective keyword; or
a winning rate prediction function for determining the respective winning rate for the item bidding price or the keyword bidding price.

16. The method in claim 15, wherein:
one or more of:
the campaign type, as provided by the user, comprises an auto bidding or a keyword bidding;
the respective campaign objective, as provided by the user, comprises one of: an optimal total-clicks, an optimal total revenue, or an optimal retum-of-ad-return;
the respective cost function, as provided by the user, is associated with an ordered sequence of bidding prices for multiple bids; or
the winning rate prediction function, as provided by the user, is associated with one of: a diminishing market price distribution or a uniform market price distribution; and
the respective utility function for the respective campaign item or the respective keyword is associated with the respective campaign objective.

17. The method in claim 14 further comprising
determining the respective floor price for the respective campaign item or the respective keyword based at least in part on a respective cost-per-click, a respective revenue-per-click, a respective click count, a respective prior floor price, and a respective prior click count for the respective campaign item or the respective keyword.

18. The method in claim 11, wherein:
the respective bidding function for the respective target of the respective department comprises one of:
(a)
$${\begin{matrix}{max}_{{b}_{i} \left(\right)} {\sum }_{i} {t}_{i} {\int }_{r} u \left(r\right) w \left({b}_{i} \left(r\right)\right) {p}_{r} \left(r\right) d r \\ s . t . {\sum }_{i} {T}_{i} {\int }_{r} c \left({b}_{i} \left(r\right)\right) w \left({b}_{i} \left(r\right)\right) {p}_{r} \left(r\right) d r \leq B , {b}_{∈} \leq \text{} {b}_{i} \leq {v}_{i} .\end{matrix}}_{,}$$
wherein:
Tᵢ is a campaign demand for item i of a campaign, the campaign comprising the respective target;
r is a click-through-rate (CTR) for item i;
u(r) is a utility function for CTR r for the campaign;
bᵢ(r) is a bidding price for CTR r for item i;
w(bᵢ(r)) is a winning rate for bidding price bᵢ(r);
pᵣ(r) is a distribution of CTR r;
c(bᵢ(r)) is a cost function for bidding price bᵢ(r);
B is a budget for the campaign;
b_{ε} is a floor price for the campaign; and
vᵢ is a revenue for item i;
or
(b)
$${\begin{matrix}{max}_{{b}_{{k}_{i}}} {\sum }_{{k}_{i} ∈ K} {T}_{{k}_{i}} u \left({b}_{{k}_{i}}\right) w \left({b}_{{k}_{i}}\right) {r}_{{k}_{i}} \\ s . t . {\sum }_{{k}_{i} ∈ K} {T}_{{k}_{i}} c \left({b}_{{k}_{i}}\right) w \left({b}_{{k}_{i}}\right) {r}_{{k}_{i}} \leq B , {b}_{e} \leq {b}_{{k}_{i}} \leq {b}_{{k}_{i}} ∀ i ,\end{matrix}}_{,}$$
wherein:
Tₖᵢ is a campaign demand for keyword kᵢ of a keyword group, the keyword group comprising the respective target;
rₖᵢ is a click-through-rate (CTR) for keyword kᵢ;
bₖ is a bidding price for keyword kᵢ;
u(bₖ) is a utility function for bidding price bₖ;
w(bₖ) is a winning rate for bidding price bₖ;
c(bₖ) is a cost function for bidding price bₖ;
B is a budget for the keyword group;
b_{ε} is a floor price for the keyword group; and
vₖᵢ is a revenue for keyword kᵢ.

19. The method in claim 18, wherein:
solving, by using the one or more processors, the respective bidding function further comprises solving, by using the one or more processors, the respective bidding function based at least in part on a Lagrangian function and one or more Euler-Lagrange conditions; and
the Lagrangian function comprises one of:
(a)
$$\begin{matrix}L \left({b}_{i} \left(r\right) , λ\right) = \sum {}_{i} {T}_{i} {\int }_{r} u \left(r\right) w \left({b}_{i} \left(r\right)\right) {p}_{r} \left(r\right) d r \text{} + {λ}_{1} \left(B -\right) \\ \sum {}_{i} {T}_{i} {\int }_{r} c \left({b}_{i} \left(r\right)\right) w \left({b}_{i} \left(r\right) {p}_{r} \left(r\right) d r - {s}_{1}^{2}\right) + {λ}_{2} \left({v}_{i} - {b}_{i} - {s}_{2}^{2}\right) + {λ}_{3} \left({b}_{i} - {b}_{ε}\right) - \\ \left({s}_{3}^{2}\right) ;\end{matrix}$$
or
(b)
$$\begin{matrix}L \left({b}_{{k}_{i}} , λ\right) = \sum {}_{{k}_{i} ∈ K} {T}_{{k}_{i}} u \left({b}_{{k}_{i}}\right) w \left({b}_{{k}_{i}}\right) {r}_{{k}_{i}} + {λ}_{1} \left(B - \sum {}_{i} {T}_{{k}_{i}} c \left({b}_{{k}_{i}}\right) w \left({b}_{{k}_{i}}\right) {r}_{{k}_{i}}\right) + \\ {λ}_{2} \left({v}_{{k}_{i}} - {b}_{{k}_{i}} - {s}_{2}^{2}\right) + {λ}_{3} \left({b}_{{k}_{i}} - {b}_{ε} - {s}_{3}^{2}\right) ,\end{matrix}$$
wherein:
each of λ₁, λ₂, and λ₃ is a Lagrange multiplier; and
each of s₁, s₂, and s₃ is a variable.

20. The method in claim 19, wherein:
the one or more Euler-Lagrange conditions comprises one of:
(c)
$$\begin{matrix}B - {T}_{i} {\int }_{r} c \left({b}_{i} \left(r\right)\right) w \left({b}_{i} \left(r\right)\right) {p}_{r} \left(r\right) d r - {s}_{1}^{2} = 0 ; \text{and} \\ {b}_{i} \left(r\right) = \sqrt{\frac{{l}^{2}}{{r}_{p}^{2} \left({p}_{i}\right)} + \frac{l u \left(r\right)}{{λ}_{1} {r}_{p} \left({p}_{i}\right)} - \frac{l}{{r}_{p} \left({p}_{i}\right)}} ;\end{matrix}$$
or
(d)
$$\begin{matrix}B - {T}_{{k}_{i}} C \left({b}_{{k}_{i}}\right) w \left({b}_{{k}_{i}}\right) {r}_{{k}_{i}} \text{} = 0 ; \text{and} \\ {b}_{{k}_{i}} = \sqrt{\frac{{l}^{2}}{{r}_{p}^{2} \left({k}_{i}\right)} + \frac{l u \left({b}_{{k}_{i}}\right)}{{λ}_{1} {r}_{p} \left({k}_{i}\right)} \text{}} - \frac{l}{{r}_{p} \left({k}_{i}\right)} ,\end{matrix}$$
wherein:
l is a constant;
rₚ(Pᵢ) is a predicted click-through-rate (CTR) for product Pᵢ; and
rₚ(kᵢ) is a predicted click-through-rate (CTR) for keyword kᵢ.
